(19) United States
(12) Patent Application Publication
(10) Pub. No.: US 2013/0036431 A1
(43) Pub. Date: Feb. 7, 2013

(54) Constraining Execution of Specified Device Drivers

(71) Applicants: John R. Douceur, Bellevue, WA (US); Jonathan R. Howell, Seattle, WA (US)

(72) Inventors: John R. Douceur, Bellevue, WA (US); Jonathan R. Howell, Seattle, WA (US)

(73) Assignee: Microsoft Corporation, Redmond, WA (US)

(21) Appl. No.: 13/196,235

(22) Filed: Aug. 2, 2011

(51) Int. Cl. G06F 3/00

(52) U.S. Cl. 719/327

(57) ABSTRACT

Techniques for allowing peripheral-device manufacturers to specify drivers for use with these devices and then loading these manufacturer-specified drivers in a manner that constrains operation of the drivers are described herein. In some instances, the techniques constrain operation of the drivers by loading these drivers into isolated containers. By loading such a driver into an isolated container, the techniques protect the host computer from harm caused by a buggy or malicious device driver. Furthermore, by loading a device driver that a manufacturer of the corresponding device specifies, the techniques allow this manufacturer to select a driver that is unlikely to harm the peripheral device itself In tandem, the techniques provide a framework that protects both the peripheral device and the host computer to which the peripheral device couples.

### RELATED APPLICATION

This application is related to U.S. patent application Ser. No. 12/463,892 filed on May 11, 2009 and entitled “Executing Native-Code Applications in a Browser”, which is herein incorporated by reference in its entirety.

### BACKGROUND

In a current computing device, installing a device driver requires user intervention due to the ability of an installed driver to break or compromise the computing device. This places a burden on users, who often do not have the technical expertise to evaluate whether a device driver is safe to install. If the user mistakenly installs a device driver that does not function properly, further user action—and possibly significant expertise—may be needed to remove the faulty driver.

### SUMMARY

Techniques for allowing peripheral-device manufacturers to specify drivers for use with these devices and then operating these manufacturer-specified drivers in a constrained manner are described herein. By constraining the operation of this driver (e.g., by loading such a driver into an isolated container), the techniques protect against the device driver harming the host computer. Furthermore, by loading a device that a manufacturer of the corresponding device specifies, the techniques allow this manufacturer to select a driver that is unlikely to harm the peripheral device itself In tandem, the techniques provide a framework that protects both the peripheral device and the host computer to which the peripheral device couples.

This summary is provided to introduce concepts that are further described below in the detailed description. This summary is not intended to identify essential features of the claimed subject matter, nor is it intended for use in determining the scope of the claimed subject matter. Furthermore, the term “techniques” includes devices, systems, methods, computer-readable media, architectures, and the like, as the context permits.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example computing architecture that includes a peripheral device coupled to a host computer. In response to the device coupling to the computer, the computer may retrieve a driver specified by a manufacturer of the device and may load the driver in an isolated container provided by the computer. In the event that the manufacturer does not specify a driver, the host computer may retrieve a driver specified by a class of device that includes the coupled peripheral device.

FIG. 2 illustrates an example process for allowing a manufacturer of a peripheral device to specify a particular driver for use with the peripheral device. In the event that the manufacturer does not specify a driver, the process may load a driver associated with a class of the device. In event that the class does not specify a driver, the process may allow a user to select a driver or may inform the user that no driver exists for the particular peripheral device.

FIG. 3 illustrates an example process for loading a driver specified by a peripheral device in a manner that constrains operation of the driver (e.g. by loading the driver into a portion of memory of a host computer that is enforced by hardware of the host computer).

### DETAILED DESCRIPTION

This disclosure describes techniques that enable device drivers to be safely installed without user intervention. The operating system employs device-manufacturer or device-class information to select a driver for the device, with the driver executing in a constrained manner (e.g., executing within a strongly isolated container that protects other code and data on the computer from the actions of the driver). The driver is then given a connection to the device that it manages

In some instances, the techniques allow peripheral-device manufacturers to specify drivers for use with these devices. The techniques then load these manufacturer-specified drivers into isolated containers to protect the device drivers from harming host computers. Furthermore, by loading a device driver that a manufacturer of the corresponding device specifies, the techniques allow this manufacturer to select a driver that is unlikely to harm the peripheral device itself In tandem, the techniques provide a framework that protects the peripheral device as well as the host computer to which the peripheral device couples.

### Overview

A device driver is a software component that interfaces between a physical device and other software that wants to communicate with the device. This other software might be applications or components within the operating system. The device driver communicates with the hardware interface of the physical device, typically using fairly low-level communication primitives. The driver also communicates with other software, typically using fairly high-level semantics. The job of the device driver is to provide other software with a high-level interface to the functionality of the hardware device

Devices attach to a host computer through various physical interfaces, such as the Peripheral Component Interconnect (PCI) bus, Universal Serial Bus (USB), parallel port, and/or other types of physical interfaces. The computer system includes a controller for each interface. Some software is used to communicate with the interface controller, but this software is not typically part of each device driver. Instead, the interface driver is a separate software component whose job is to shuttle device-specific commands and data between each device driver and its associated physical device.

Some interfaces, such as USB, define a set of standard device classes. Using this as an example, a USB device can identify itself to the USB interface driver as a member of a standard class, meaning that (1) the function of the device is appropriate to the class, and (2) the device knows how to communicate via a standard protocol for this class. For example, standard USB device classes include mass storage, human interface device (HID), video, physical interface device (PID), image, printer, audio, and the like.

The “mass storage device” class, for instance, is used by mass storage devices (e.g., disks, memory sticks, etc.), as well as devices that have other functions but present their data to the computer in the manner of a mass storage device. An example of the latter is a digital camera. Although a camera does far more than store data, when the camera couples to a host computer, the host computer sees the camera as though it were merely a storage device. This means, for example, there is no means for the computer to ask the camera to take a picture. Instead, the computer can simply read and write the storage on the camera, for example to retrieve images stored therein.

While a few example classes have been listed above, not all USB devices (as well as other types of peripheral devices) conform to a standard class. Some devices have communication semantics that are particular to a manufacturer. For instance, a complex computer-attached instrument such as an oscilloscope may utilize an interface that does not fit any standard device class. Furthermore, some USB devices can communicate via both a standard device-class protocol and also a manufacturer-specific protocol. For instance, certain input devices communicate via the USB “human interface device” class, while also having non-standard features that are accessed via a manufacturer-specific protocol.

Conventional operating systems, meanwhile, often include innate drivers for communicating with standard device classes (e.g., standard USB device classes). Thus, when a user plugs in a USB device, and the USB interface driver queries the device to discover its device class, if the device supports a standard class, the interface driver will connect that device to the innate device driver for that class. On the other hand, if the device does not support a standard class, the operating system cannot communicate with the device without first installing a driver for that device. Some devices are packaged along with a storage medium (e.g., a compact disc (CD)) that contains the driver for that device. In these instances, users are instructed to load the driver from the CD and install the driver onto their system. Alternatively, devices may instead obtain their drivers from servers on the Internet, and again the user is prompted to install the driver on their system.

In general, users are involved in the decision to install a device driver, because conventional operating systems are structured such that the driver software has significant access to critical system resources. The user thus makes a judgment regarding whether the driver is trustworthy, and may install the driver if the user is confident that the driver is not broken or malicious. In practice, however, most users lack the technical expertise to evaluate whether a device driver is safe to install. And even those users that have such technical expertise rarely vet a driver to make sure the driver does not contain critical bugs or malware.

To remove the need for a user to make a trust decision or vet a driver in the manner described above, the techniques described below allow a device driver to execute in a constrained manner, thereby protecting the critical resources of the host computer from a buggy or malicious driver. In some instances, the techniques constrain the driver by loading the driver in an isolated container that is provided via hardware of the host computer enforcing a memory region in which the driver executes. In other instances, the techniques effectively load the driver in an isolated container by allowing the driver to operate in user mode free from access to the kernel of the host computer, by programmatically ensuring—prior to runtime of the driver—that the driver cannot harm resources of the host computer, or the like. In some instances, the techniques may provide an isolated container utilizing the techniques described in the '892 application, incorporated by reference above.

However, unlike the case with application programs, this isolation is not sufficient to protect the peripheral device that the driver controls from potential damage caused by a buggy or malicious driver. To remedy this potential for harm, the techniques described herein presume that a driver will not harm a physical peripheral device if the manufacturer of the device is able to specify which driver is allowed to communicate with the device.

The techniques described below achieve this control by employing a database into which individual device manufacturers may register their devices and drivers. Then, when an operating system of a host computer receives device information from the device, if the device information includes an indication of the device manufacturer, the operating system looks up this manufacturer in the database. The database may be stored locally, at a defined network location, or both. If the database contains a record for this manufacturer, the operating system uses the information in the record to identify an appropriate driver for the device. The operating system then locates the driver and loads the driver in a constrained manner and connects it to the device.

If the device information does not include an indication of the device manufacturer, or if the database does not contain a record for this manufacturer, the operating system may continue to attempt to identify an appropriate driver for the device. If the device information includes an indication of the device class, the operating system looks up this device class in the database. If the database contains a record for this device class, the operating system uses the information in the record to identify an appropriate driver for the device. The operating system then locates the driver and loads the driver in a constrained manner and connects it to the device.

If the device information does not include an indication of the device manufacturer or device class, or if the database does not contain a record for the identified manufacturer or identified device class, the operating system may allow a user of the host computer to select a driver or may inform the user that no driver is available for the device.

The described techniques thus allow a manufacturer to ensure that the appropriate driver for the peripheral device is loaded, rather than relying on the user to install the proper driver. Because the device effectively specifies which driver to use, little or no danger exists that a malicious driver will corrupt the device. In addition, a user's host computer is protected from malicious drivers because the driver is loaded into a secure container or is otherwise constrained from harming the host computer.

### Example Computing Architecture

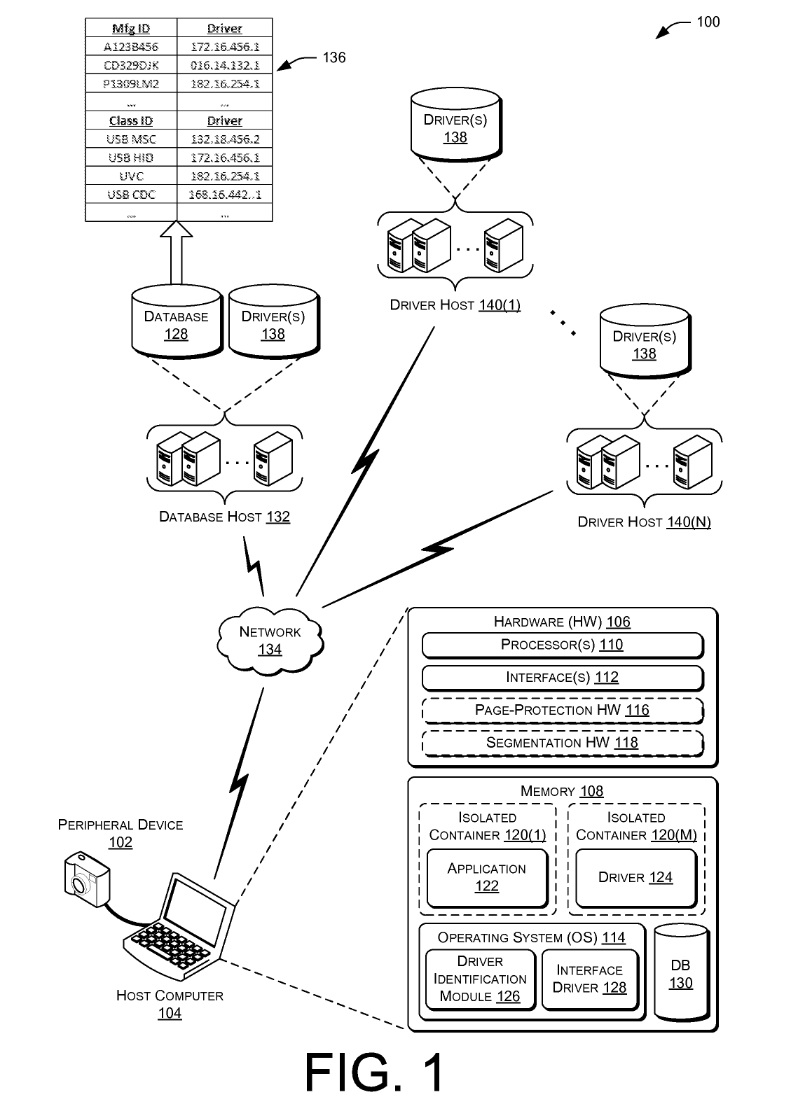

FIG. 1 illustrates an example computing architecture 100 that includes a peripheral device 102 coupled to a host computer 104. As described above, in response to the device 102 coupling to the computer 104, the computer 104 may retrieve a driver specified by a manufacturer of the device 102 and may load the driver in an isolated container provided by the computer 104. In the event that the manufacturer does not specify a driver, the host computer 104 may retrieve a driver specified by a class of device that includes the coupled peripheral device 102.

While FIG. 1 depicts the peripheral device 102 as a camera, it is to be appreciated that the described techniques may apply to any other type of peripheral device, such as memory sticks, hard drives, web cameras, and the like. Similarly, while FIG. 1 illustrates the host computer 104 as a laptop computer, the techniques may apply to any other type of client computing device, including desktop computers, tablet computers, thin clients, mobile telephones, portable music players, and the like.

As illustrated, the host computer 104 includes hardware 106 and memory 108. The hardware 106 of the host computer 104 includes one or more processors 110 and one or more interfaces 112, which may include any type of physical interface capable of coupling the host computer 104 with the peripheral device 102, as described above.

The memory 108, meanwhile, includes an operating system (OS) 114 that manages resources of the computer 104 and that provide various services for applications executing on the computer 104. The memory 108 (and other memories described herein) may comprise computer-readable media. This computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

In some instances, the hardware 106 of the host computer 104 may also include page-protection hardware 116 and/or segmentation hardware 118 that individually or collectively creates or defines isolated containers 120(1), . . . , 120(M) within the memory 108. For instance, an application 122 operating on the computer 104 may be assigned to execute within the isolated container 120(1), which comprises a memory region that is enforced by the page-protection hardware 116, the segmentation hardware 118, and/or other hardware of the computer 104. In addition, the host computer 104 may provide for a very narrow interface from the isolated container 120(1) by restricting system calls made by the application 122. By enforcing the memory region assigned to the application 122 with hardware and by restricting these system calls, the host computer 104 effectively isolates the application 122 within the container 120(1). As such, the application is generally unable to modify memory other than the memory defined by the isolated container 120(1) and, hence, is unable to harm the host computer 104.

Similarly, after the host computer 104 identifies a driver 124 for use within the peripheral device 102, the host computer 104 may load the driver 124 into an isolated container 120(M). By doing so, the host computer 104 reduces or eliminates the harm that the driver 124 is able to bring upon applications and data of the host computer 104 in the event that the driver 124 is buggy or malicious.

While the host computer 104 may provide isolated containers 120(1)-(M) via hardware-enforced memory, other implementations may constrain behavior of the driver 124 in other ways. For instance, the host computer 104 may effectively isolate the driver 124 by allowing the driver 124 to operate in user mode. By doing so, the host computer 104 does not provide the driver 124 with access to a kernel of the host computer 104. As such, the driver 124 would lack authority to damage other applications or data operating or stored upon the host computer 104. In yet another implementation, a developer or software operating on the host computer may constrain the driver 124 by programmatically verifying, prior to run-time of the driver 124, that the driver 124 is unable to modify or harm memory of the host computer 104 other than the memory into which the driver 124 is loaded.

By constraining the driver (e.g., by loading the driver 124 into the isolated container 120(M)), the host computer 104 limits the harm that a buggy or malicious driver is able to cause other applications and data of the computer 104. However, because the host computer 104 provides a channel for the driver 124 to communicate with the corresponding peripheral device 102, a buggy or malicious driver may still harm the device 102 itself As such, the host computer 104 may allow an entity associated with the device (e.g., a device manufacturer, retailer, etc.) to specify a driver for use with the device 102.

In this regard, the operating system 114 stores or otherwise has access to a driver identification module 126 and an interface driver 128. The interface driver 128 shuttles device-specific commands and data between the device driver 124 and the corresponding peripheral device 102. In addition, the host computer 104 stores or otherwise has access to a database (DB) 130 (which may represent multiple databases stored at different locations). The database 130 stores a mapping of manufacture identifiers to drivers specified by these manufacturers. In addition, the database 130 may also store a mapping of device classes to drivers for use with devices of the corresponding classes. The driver identification module 126 may then reference the database 130 when a peripheral device couples to the host computer 104 to identify a driver for use with the coupled device.

As such, a manufacturer of the illustrated camera 102 may store, within the database, an indication of one or more drivers that the driver identification module 126 is to use when the device 102 couples to the host computer 104 and/or to other host computers. In the event that a peripheral device 102—such as the camera—does not provide a manufacturer identifier (or if the database 130 does not indicate a driver for use with a provided identifier), the driver identification module 126 may reference a class of the device 102 and may use this class to locate an appropriate driver.

For instance, envision that the illustrated camera 102 does not provide a manufacturer identifier upon coupling to the host computer 104. As such, when the camera provides an indication that it is a USB mass storage device, the driver identification module 126 may determine, with reference to the database 130, an appropriate driver for use with mass storage devices. With this information, the driver identification module 126 may locate the driver and load this driver within an isolated container provided by the host computer. In the event that a peripheral device provides neither a manufacturer identifier nor a class identifier, the driver identification module 126 may either inform a user of the host computer 104 that no available driver exists or may allow the user to choose a driver for use with the device.

As illustrated, the host computer 104 may store the database 130 and/or the database may be located remotely from the computer 104. For instance, FIG. 1 illustrates that a database host 132 stores the database 130. In instances where the database 130 resides remotely from the host computer 104, and the host computer 104 does not store a copy of the database 130 locally, the driver identification module 126 may request the database 130 or the appropriate information from the database 130 from the database host 132 over a network 134. The network 134 is representative of any one or combination of multiple different types of networks, such as the Internet, cable networks, cellular networks, wireless networks, and wired networks.

As illustrated, the database 130 comprises a mapping 136 of manufacturer identifiers to drivers and class identifiers to drivers. In this example, the database 130 includes pointers to the drivers associated with the respective identifiers, although the database 130 may identify these drivers in any other way in other implementations. In addition, the database host 132 may store one or more drivers 138 identified within the database 130. As such, when the driver identification module 126 queries the database host 132, the database host 132 may provide a location to the corresponding and/or the actual driver itself Additionally or alternatively, one or more network-accessible driver hosts 140(1), . . . , 140(N) may store one or more drivers 138 indicated in the database 130.

Regardless of whether the driver identification module 126 accesses the database 130 locally or remotely, upon identifying the driver corresponding to the peripheral device 102, the module 126 may load the driver within an isolated container provided by the host computer 104. By utilizing this isolation along with providing the ability for a manufacturer of the peripheral device 102 to identify the appropriate driver for use with the device 102, the techniques limit the harm that a buggy or malicious device is able to cause to both the host computer 104 and the device 102 itself

### Example Processes

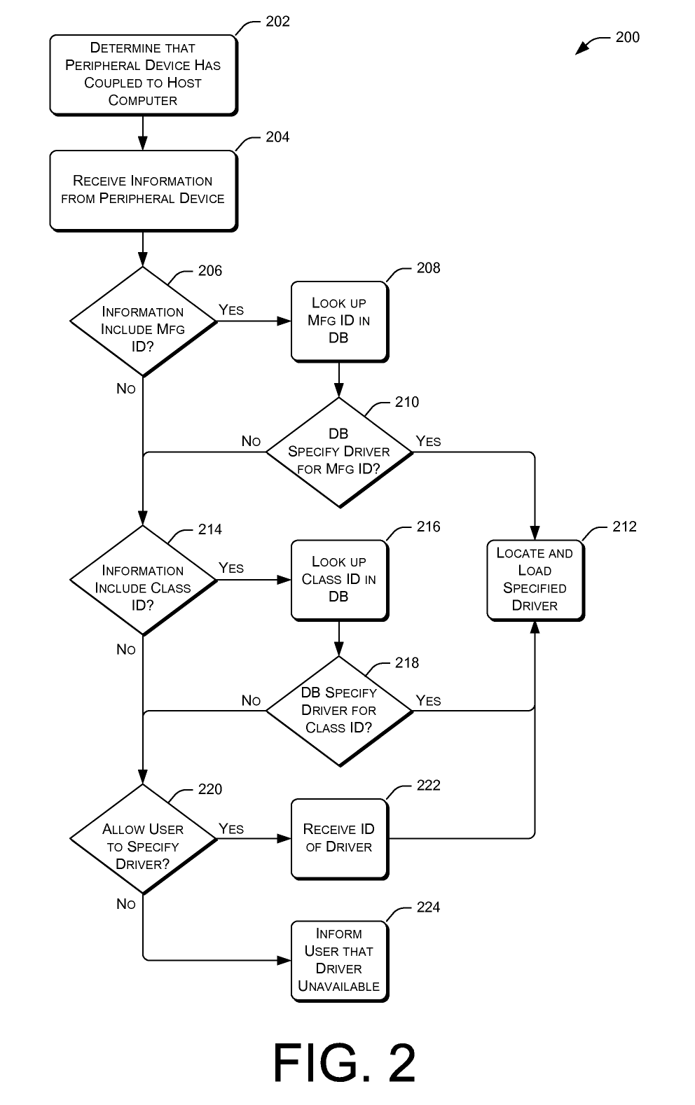

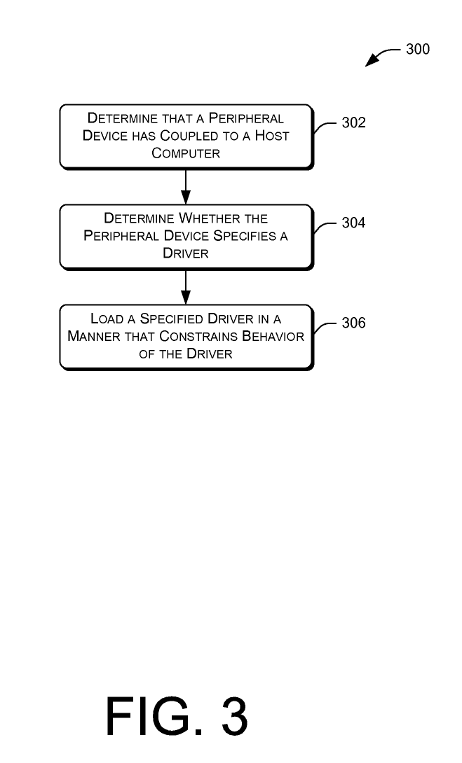

FIGS. 2-3 comprise illustrative flow diagrams of example processes that may be implemented within the architecture 100 of FIG. 1 and/or within other architectures. Each of these processes is illustrated as a collection of acts in a logical flow graph, which represents a sequence of operations that can be implemented in hardware, software, or a combination thereof. In the context of software, the blocks represent computer instructions stored on one or more computer-readable storage media that, when executed by one or more processors, perform the recited operations. Note that the order in which the process is described is not intended to be construed as a limitation, and any number of the described acts can be combined in any order to implement the process, or an alternate process. Additionally, individual blocks may be deleted from the process without departing from the spirit and scope of the subject matter described herein.

FIG. 2 illustrates an example process 200 for allowing a manufacturer of a peripheral device, such as the device 102, to specify a particular driver for use with the peripheral device. In some instances, the driver identification module 126 may implement the process 200 in whole or in part.

At 202, the driver identification module 126 determines that a peripheral device 102 has coupled to the host computer 104. In response, the module 126 may request information regarding the peripheral device 102, which the module 126 may receive at 204. At 206, the module 126 queries whether the information received from the peripheral device 102 includes a manufacturer identifier indicating a manufacturer of the peripheral device 102. If so, then the module 126 looks up this manufacturer identifier within the database 130 at 208. At 210, the module 126 queries whether the database 130 specifies a driver for the manufacturer identifier. If so, then the module 126 locates and loads the specified driver at 212. As discussed above, the module 126 may constrain behavior of this driver by, for example, loading this driver into an isolated container, running the driver in user mode, programmatically verifying the safeness of the driver, or the like.

If, however, the peripheral device 102 did not provide a manufacturer identifier, or if this identifier did not specify a driver within the database 130, the module 126 queries, at 214, whether the information received from the peripheral device 102 includes a class of the device 102. If so, then the module 126 looks up this class identifier in the database 130 at 216 and, at 218, the module 126 queries whether the database 130 specifies a driver for the provided class identifier. If so, then the module 126 locates and loads this driver in a manner that constrains the ability of the driver to harm the host computer 104.

If, however, the peripheral device 102 did not provide a class identifier, or if this identifier did not specify a driver within the database 130, the module 126 determines whether or not to allow a user to specify a driver for use with the peripheral device 102 at 220. In some instances, this decision may be a default setting, while in other instances a user of the host computer 104 may provide this setting. If the module 126 determines that the user is able to provide a driver, then at 220 the module 126 may receive an identification of a driver from the user at 222 before locating and loading this driver at 212. If, however, the module 126 determines that the user is unable to provide an identification of a driver, then the module 126 may inform the user that no available driver exists for this peripheral device 102 at 224.

FIG. 3 illustrates an example process 300 for loading a driver specified by a peripheral device in a manner that constrains operation of the driver. For instance, the process 300 may load the driver into a portion of memory of a host computer that is enforced by hardware of the host computer. Again, in some instances the driver identification module 126 may perform a portion or the entire process 300.

At 302, the driver identification module 126 determines that a peripheral device 102 has coupled to a host computer 104. At 304, the module 126 determines whether the coupled device specifies a driver for use with the device. For instance, the module 126 may determine whether the device specifies a driver by providing a manufacturer identifier associated with the device and/or by providing a class identifier associated with the device. If so, then at 306 the module 126 locates the driver from the database 130 using the provided identifier(s) and loads the specified driver in a manner that constrains the behavior of the driver. For instance, the module 126 may locate a driver associated with the manufacturer identifier of the device or with the class identifier of the device. The module 126 may load this driver in an isolated container enforced by hardware of the host computer 104, may run this driver in user mode as opposed to kernel mode, may programmatically verify that the driver cannot harm the host computer, or may constrain behavior of the driver in another manner.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. One or more computer-readable media storing computer-executable instructions that, when executed on one or more processors, cause the one or more processors to perform acts comprising:
determining that a peripheral device has coupled to a host computer via an interface of the host computer; and
receiving, via the interface, information from the peripheral device at least partly in response to the determining;
determining whether the information received from the peripheral device includes a manufacturer identifier identifying a manufacturer of the peripheral device; and
at least partly in response to determining that the information received from the peripheral device includes the manufacturer identifier:
referencing a database to determine whether the manufacturer associated with the manufacturer identifier has previously specified, in the database, a driver for use with the peripheral device; and
loading the specified driver in an isolated container provided by the host computer at least partly in response to determining that the manufacturer has specified the driver for use with the peripheral device.

2. One or more computer-readable media as recited in claim 1, the acts further comprising:
at least partly in response to determining that: (1) the information received from the peripheral device does not include the manufacturer identifier, or (2) the manufacturer has not previously specified, in the database, a driver for use with the peripheral device:
determining whether the information received from the peripheral device includes a class identifier indicating a class of the peripheral device; and
at least partly in response to determining that the information received from the peripheral device includes the class identifier:
referencing the database to determine whether the class associated with the class identifier specifies, in the database, a driver for use with the peripheral device; and
loading the specified driver in the isolated container at least partly in response to determining that the class has specified the driver for use with the peripheral device.

3. One or more computer-readable media as recited in claim 2, the acts further comprising:
at least partly in response to determining that: (1) the information received from the peripheral device does not include the class identifier, or (2) the class does not specify, in the database, a driver for use with the peripheral device:
informing a user that no driver is available for the peripheral device.

4. One or more computer-readable media as recited in claim 2, the acts further comprising:
at least partly in response to determining that: (1) the information received from the peripheral device does not include the class identifier, or (2) the class does not specify, in the database, a driver for use with the peripheral device:
allowing the user to specify a driver for use with the peripheral device; and
loading the driver specified by the user into the isolated container.

5. One or more computer-readable media as recited in claim 1, wherein the host computer provides the isolated container by loading the driver within a portion of memory of the host computer that is enforced by hardware of the host computer.

6. One or more computer-readable media as recited in claim 5, wherein the hardware comprises page-protection hardware or segmentation hardware of the host computer.

7. One or more computer-readable media as recited in claim 1, wherein the host computer provides the isolated container by:
loading the driver within a portion of memory of the host computer that is enforced by hardware of the host computer; and
restricting system calls made by the driver from the portion of memory, the system calls for services provided outside of the portion of memory.

8. One or more computer-readable media as recited in claim 1, wherein the host computer provides the isolated container by allowing the driver to execute in user mode of the host computer.

9. One or more computer-readable media as recited in claim 1, wherein the host computer provides the isolated container by disallowing the driver from executing in kernel mode of the host computer.

10. One or more computer-readable media as recited in claim 1, wherein the host computer provides the isolated container by programmatically verifying, prior to run-time of the driver, that the driver is unable to harm the host computer during execution.

11. A computing device comprising:
an interface;
one or more processors;
memory; and
a driver identification module, stored in the memory and executable on the one or more processors, the driver identification module being configured to:
determine when a peripheral device has coupled to the computing device via the interface;
receive, from the peripheral device and via the interface, a manufacturer identifier identifying a manufacture of the peripheral device;
locate a driver for use with the peripheral device as specified by the manufacturer associated with the manufacturer identifier; and
load the driver into a portion of the memory of the computing device, the driver being at least partially constrained from modifying memory of the computing device other than the portion of memory into which the driver is loaded.

12. A computing device as recited in claim 11, wherein the driver identification module is configured to locate the driver by referencing a database that maps manufacturer identifiers to drivers specified by manufacturers associated with respective ones of the manufacturer identifiers.

13. A computing device as recited in claim 11, wherein the driver identification module is configured to locate the driver by referencing a database that maps:
manufacturer identifiers to drivers specified by manufacturers associated with respective ones of the manufacturer identifiers; and
class identifiers to drivers specified by respective classes of peripheral devices associated with respective ones of the class identifiers.

14. A computing device as recited in claim 11, wherein the driver identification module is further configured to:
receive, from the peripheral device and via the interface, a class identifier identifying a class of the peripheral device; and
when the peripheral device does not provide the manufacturer identifier or when the manufacturer does not specify a driver:
locate a driver for use with the peripheral device as specified by the class associated with the class identifier; and
load the driver specified by the class into the portion of the memory of the computing device.

15. A computing device as recited in claim 11, wherein the portion of memory into which driver is loaded is protected by hardware of the computing device to at least partially constrain the driver from modifying memory of the computing device other than the portion of memory into which the driver is loaded.

16. A computing device as recited in claim 11, wherein the memory of the computing device includes a kernel, and the portion of memory into which driver is loaded is outside of the kernel.

17. A computing device as recited in claim 11, wherein the driver is constrained prior to run-time via programmatically verifying that the driver is unable to harm, during execution of the driver, the memory other than the portion of memory into which the driver is loaded.

18. A method comprising:
determining, by a host computer, that a peripheral device has coupled to the host computer;
determining whether the peripheral device specifies a driver for use with the peripheral device; and
at least partly in response to determining that the peripheral device specifies a driver, loading the driver in a portion of memory of the host computer that is enforced by hardware of the host computer.

19. A method as recited in claim 18, wherein the determining whether the peripheral device specifies a driver comprises:
determining whether the peripheral device provides a manufacturer identifier identifying a manufacturer of the peripheral device; and
at least partly in response to the peripheral device providing a manufacturer identifier, determining whether the manufacture associated with the peripheral identifier has previously specified the driver for use with the peripheral device.

20. A method as recited in claim 18, wherein the determining whether the peripheral device specifies a driver comprises:
determining whether the peripheral device provides a class identifier identifying a class of the peripheral device; and
at least partly in response to the peripheral device providing a class identifier, determining whether the class associated with the class identifier has previously specified the driver for use with the peripheral device.
